(19) United States
(12) Patent Application Publication
(10) Pub. No.: US 2016/0263596 A1
(43) Pub. Date: Sep. 15, 2016

(54) ATOMIZATION DEVICE

(71) Applicant: HoBoSon Co. Ltd., New Taipei City (TW)

(72) Inventors: Ching-Hua Wang, New Taipei City (TW); Yu-Wen Yen, New Taipei City (TW)

(21) Appl. No.: 14/656,686

(22) Filed: Mar. 12, 2015

(51) Int. Cl. B05B 7/04

(52) U.S. Cl. CPC B05B 7/0425

(57) ABSTRACT

The atomization device is provided which contains a base having two indentations oppositely and axially aligned with gradually decreasing diameters towards each other. A connection channel connects the two indentations. A first chamber and a second chamber are formed laterally between the two indentations. The first chamber has a larger height than that of the second chamber. A transmission pipe is configured inside the base connecting the first chamber and one of the opposite sides. After the fluid to be atomized is introduced into the base, it first enters the first chamber through the transmission pipe. After the first chamber is filled, fluid then enters the second chamber uniformly. In the meantime, air is forced to flow through the connection channel and fluid is as such atomized and ejected out from the second chamber with high uniformity.

### BACKGROUND OF THE INVENTION

(a) Technical Field of the Invention

The present invention is generally related to fluid atomization, and more particular to an atomization device capable of achieving highly uniform atomization.

(b) Description of the Prior Art

Atomization devices are commonly applied in daily life so as to spread fluid over a great area. For example, aromatic autosprayer atomizes aromatic fluid so that it is quickly evaporated and spread in a surrounding atmosphere.

Despite their different design, atomization devices have a common feature: a narrow flow path for the fluid and the fluid is atomized as it flows through the narrow flow path.

However, the conventional atomization devices also share a common flaw: the narrow flow path does not provide thorough atomization and there are still dews after atomization.

### SUMMARY OF THE INVENTION

The purpose of the present invention is to provide a flow path of varying diameter so that the fluid can fill up the flow path to achieve highly uniform atomization.

To achieve the objective, an atomization device is provided which contains a base having two indentations configured on two opposite sides of the base. The indentations are axially aligned and have gradually decreasing diameters towards each other. A connection channel is configured inside the base connecting the two indentations. A first chamber and a second chamber are formed laterally between the two indentations inside the base and connected together. The first chamber has a larger height than that of the second chamber. The connection channel passes through the second chamber. A transmission pipe is configured inside the base connecting the first chamber and one of the opposite sides.

As such, after the fluid to be atomized is introduced into the base, it first enters the first chamber through the transmission pipe. After the first chamber is filled, fluid then enters the second chamber uniformly. In the meantime, air is forced to flow through the connection channel and fluid is as such atomized and ejected out from the second chamber. Through the design of the present invention, enhanced and highly uniform atomization is achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an atomization device according to an embodiment of the present invention.

FIG. 2 is a perspective break-down diagram showing the various components of the atomization device of FIG. 1.

FIG. 3 is a sectional diagram of the atomization device along the A-A line of FIG. 1.

FIG. 4 is a perspective diagram showing a first base member of the atomization device of FIG. 1.

FIG. 5 is a perspective diagram showing a second base member of the atomization device of FIG. 1.

FIGS. 6 and 7 show how fluid is atomized by the atomization device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

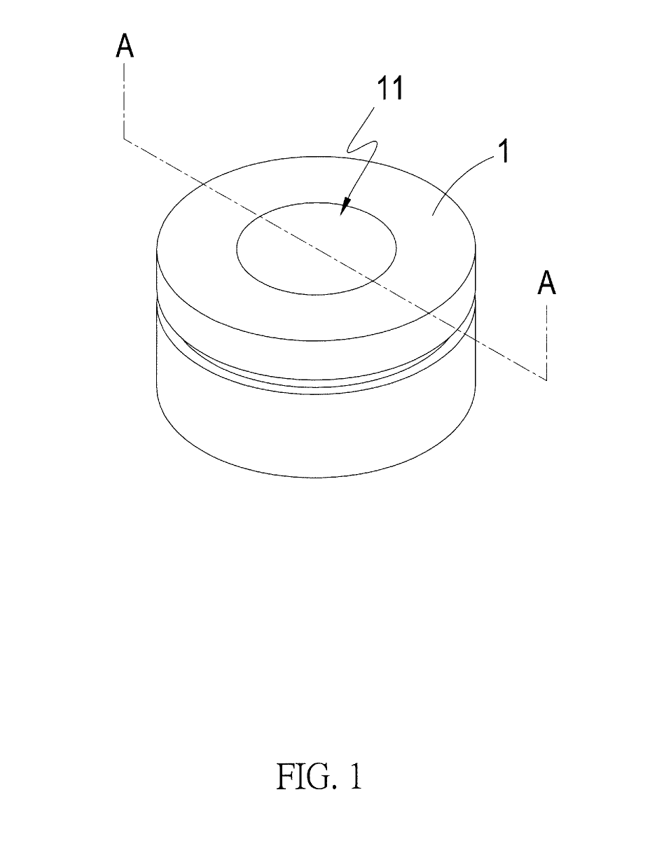

As shown in FIGS. 1 to 7, an atomization device according to an embodiment of the present invention contains the following components.

A base has two indentations configured on two opposite sides of the base. The indentations are axially aligned and have gradually decreasing diameters towards each other. A connection channel is configured inside the base connecting the two indentations.

A first chamber and a second chamber are formed laterally between the two indentations inside the base and connected together. The first chamber has a larger height than that of the second chamber. The connection channel passes through the second chamber.

A transmission pipe is configured inside the base connecting the first chamber and one of the opposite sides.

More specifically, the base contains a first base member 1 and a second base member 2 joined together. The first base member 1 has a first indentation 11 on a top side and a third indentation 14 on a bottom side of the first base member 1. The second base member 2 has a second indentation 21 on a bottom side of the second base member 2. The first and second indentations 11 and 21 function as the above-mentioned indentations whereas the third indentation is for housing the second base member 2.

On a top side of the third indentation 14, an encircling indentation 12 is configured around a central indentation 13 having a smaller depth than that of the encircling indentation 12. After the second base member 2 is joined to the first base member 1 in the third indentation 14, a top side of the second base member 2 seals the ring and central indentation 12 and 13, and the above mentioned first and second chambers are formed by the sealed ring and central indentations 12 and 13, respectively. A first channel 111 is configured inside the first base member 1 connecting the first indentation 11 and the central indentation 13.

A second channel 211 is configure inside the second base member 2 connecting the second indentation 21 and the top side of the second base member 2. The first and second channels 111 and 211 jointly form the connection channel mentioned above. The second base member 2 further has the transmission pipe 22 formed to a side of the second indentation 21 connecting the top side to a bottom side of the second base member 2. After the second base member 2 is joined to the first base member 1, the transmission pipe 22 connects the first chamber to the bottom side of the second base member 2.

In the present embodiment, the first and second indentations 11 and 21 have a semi-spherical shape, and the first indentation 11 has a greater radius than that of the second indentation 21.

In the present embodiment, the second channel 211 has a greater aperture than that of the first channel 111, and the transmission pipe 22 is perpendicular to the first chamber. In an alternative embodiment, the transmission pipe 22 is slantwise configured relative to the first chamber.

In the present embodiment, the encircling indentation 12 has a depth twice as large as that of the central indentation 13.

FIG. 1 is a perspective diagram showing the atomization device after the first and second base members are joined together. As illustrated, the atomization device has a cylindrical shape and, when put to use, the first base member 1's circumference will be used for fixation.

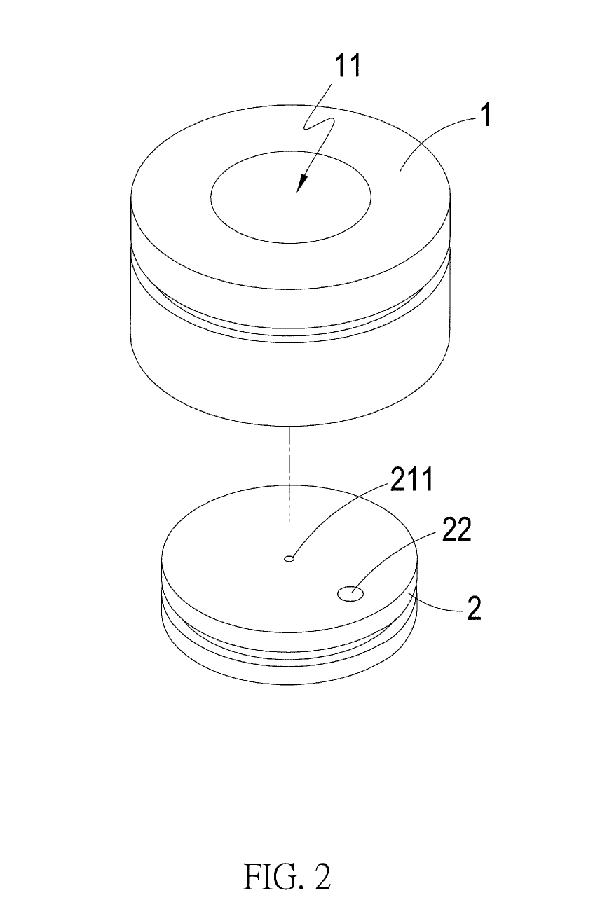

FIG. 2 is a perspective break-down diagram showing the various components of the atomization device. As illustrated, the assembly of the atomization device is achieved by embedding the second base member 2 into the third indentation 14 of the first base member 1 so that the top side of the second base member 2 seals the ring and central indentations 12 and 13 of the first base member 1.

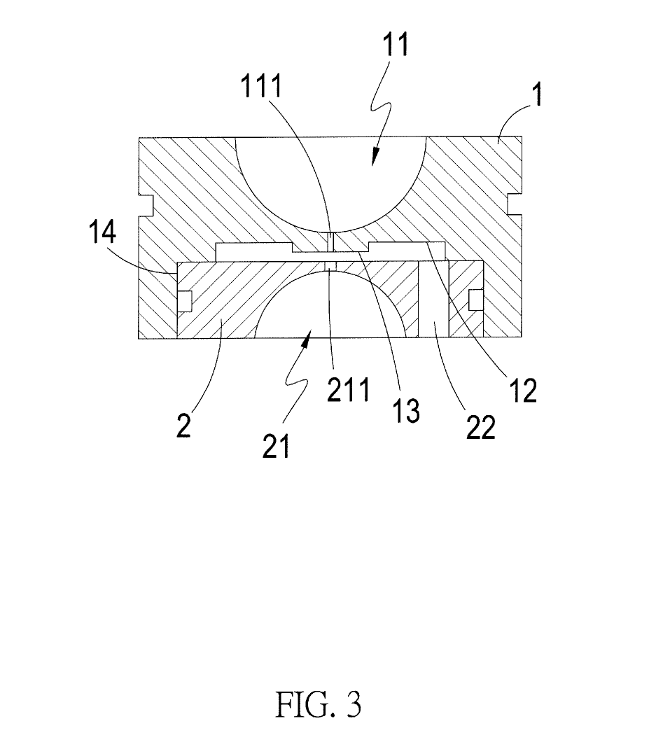

FIG. 3 is a sectional diagram of the atomization device. As illustrated, the top side of the second base member 2 seals the ring and central indentations 12 and 13 of the first base member 1. It should be obvious that the first chamber (formed by the sealed encircling indentation 12) has a greater height than that of the second chamber (formed by the sealed central indentation 13), so that the first and second chambers function similar to a Venturi tube. The first and second indentations 11 and 21 are designed to have gradually reducing diameter so as to match the Venturi tube and the first and second channels 111 and 211 are configured to pass through the constricted section of the Venturi tube.

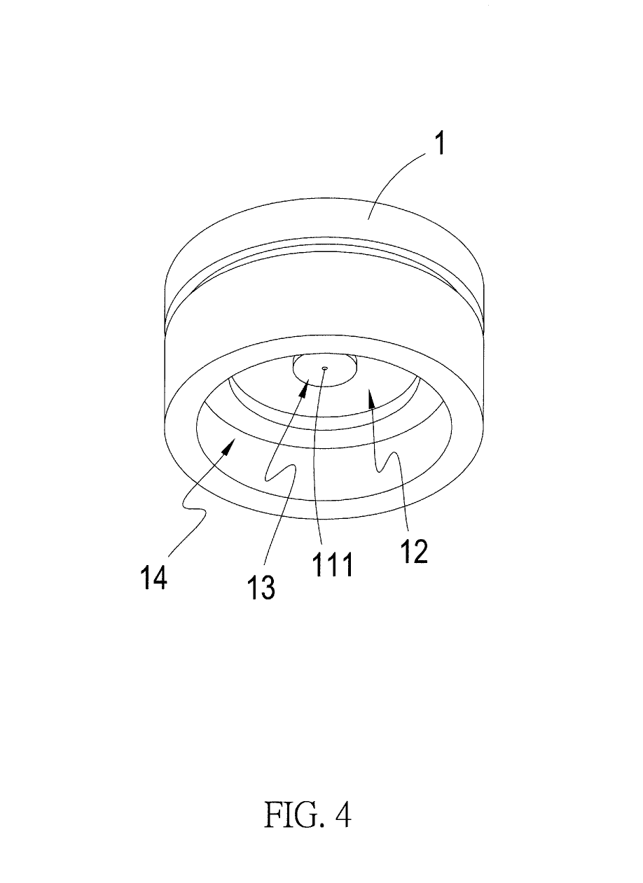

FIG. 4 is a perspective diagram showing the first base member 1. As illustrated, in the present embodiment, the encircling indentation 12 is ring-shaped whereas the central indentation 13 is circular. The first channel 111 is connected to the central indentation 13. When a fluid enters the atomization device, the first chamber (formed by the sealed encircling indentation 12) will be filled up before fluid entering the second chamber (formed by the sealed central indentation 13).

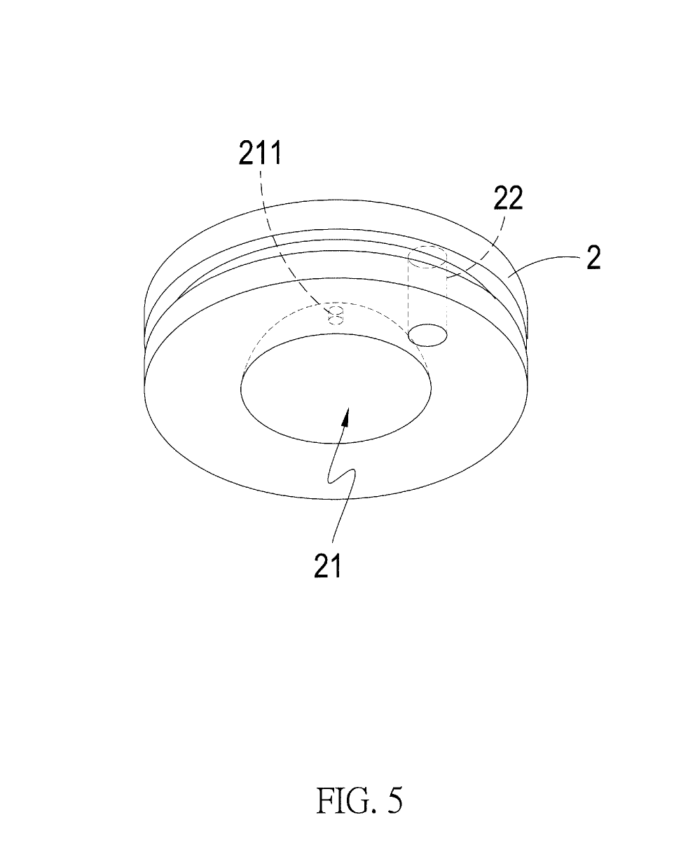

FIG. 5 is a perspective diagram showing a second base member 2. As illustrated, the transmission pipe 22 runs independently through the second base member 2, and introduces fluid into the first and second chambers. The transmission pipe 22 can be perpendicular to the first chamber, or slantwise configured relative to the first chamber.

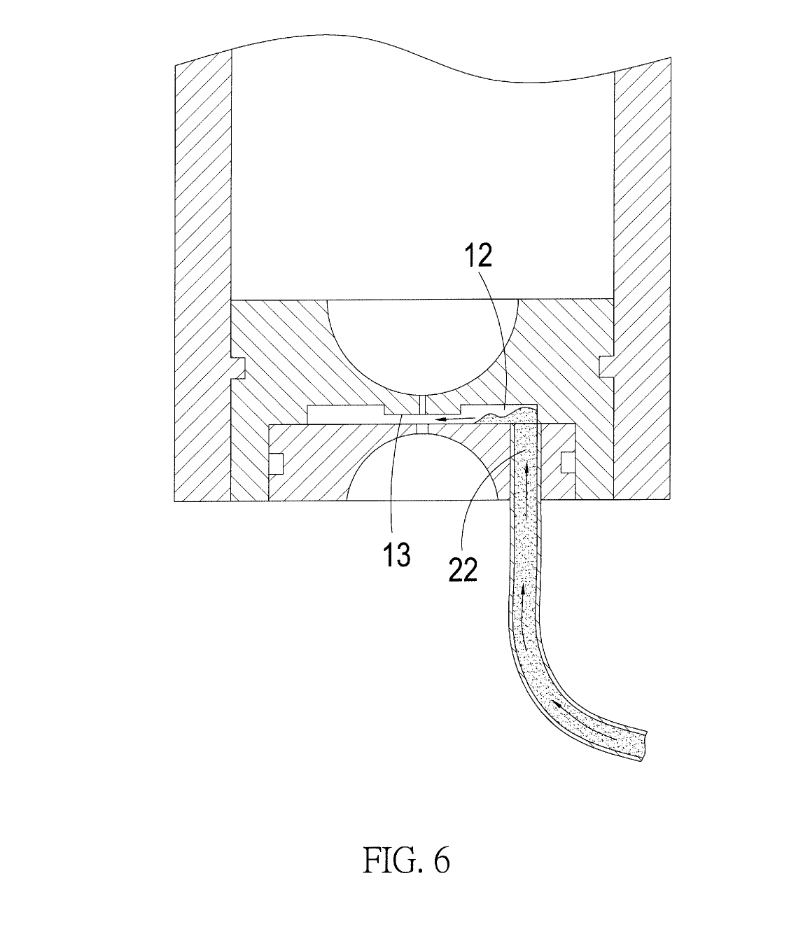

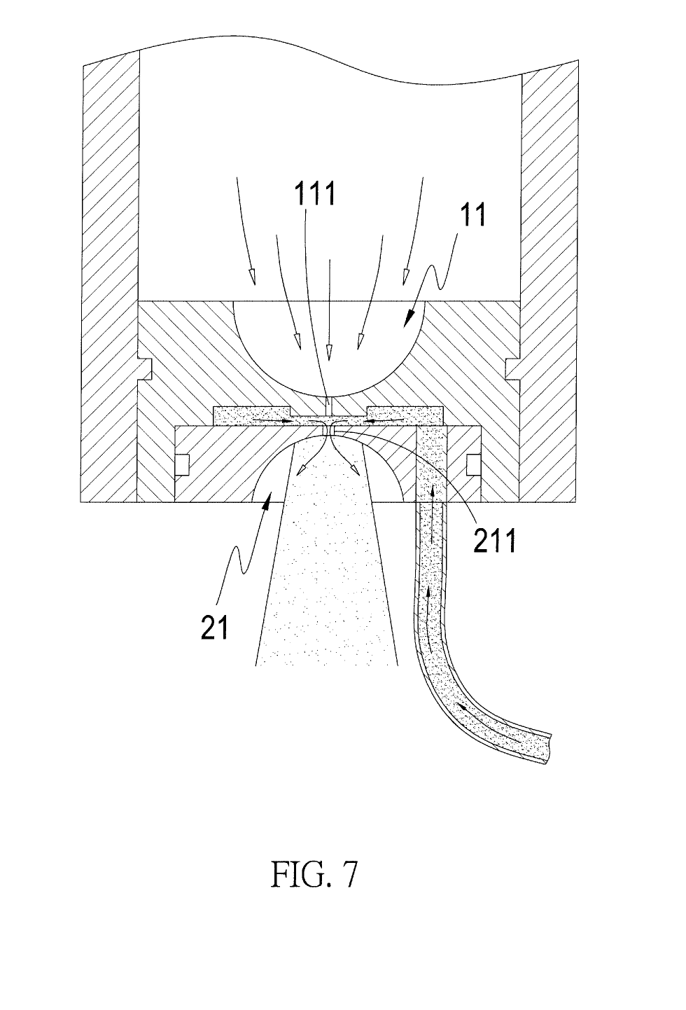

FIGS. 6 and 7 show how fluid is atomized by the atomization device. As illustrated, fluid first enters the first chamber through the transmission pipe 22. After the first chamber is filled, fluid enters the second chamber. In the meantime, air is forced to flow from the first indentation 11 of a greater radius into the second indentation 21 of a smaller radius. Fluid is as such atomized and ejected out from the second indentation 21. Through the design of the present invention, enhanced and highly uniform atomization is achieved.

The gist of the present invention lies in the simulation of the Venturi tube by a larger first chamber narrowed down to a smaller second chamber.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An atomization device, comprising:
a base having first and second indentations configured on two opposite sides of the base, respectively, and a connection channel configured inside the base connecting the first and second indentations where the first and second indentations are axially aligned and have gradually decreasing diameters towards each other, the connection channel comprises a first channel and a second channel axially aligned, and the second channel has an aperture greater than that of the first channel;
a first chamber and a second chamber formed laterally between the first and second indentations inside the base and connected together where the first chamber has a larger height than that of the second chamber, the first channel connects between the first indentation and the second chamber, the second channel connects between the second chamber and the second indentation; and
a transmission pipe configured inside the base connecting the first chamber and one of the opposite sides;
wherein a fluid to be atomized is introduced into the first and second chambers through the transmission pipe; air is forced to flow from the first indentation into the second indentation through the first and second channels; and the fluid in the second chamber is therefore atomized and ejected out from the second indentation.

2. The atomization device according to claim 1, wherein
the base comprises a first base member and a second base member joined together;
the first base member has the first indentation on a top side, an encircling indentation and a central indentation, both opposite to the first indentation; the central indentation has a smaller depth than that of the encircling indentation; the first channel is configured inside the first base member connecting the first indentation and the central indentation;
the second base member has the second indentation on a bottom side; the second channel is configure inside the second base member connecting the second indentation and a top side of the second base member; and
the transmission pipe is formed to a side of the second indentation connecting the top side to a bottom side of the second base member.

3. The atomization device according to claim 2, wherein the first base member has a third indentation on a bottom side of the first base member; and the encircling and central indentations are configured on a top side of the third indentation.

4. The atomization device according to claim 3, wherein the first and second base members are joined together by embedding the second base member into the third indentation.

5. The atomization device according to claim 2, wherein the first and second indentations have a semi-spherical shape.

6. The atomization device according to claim 5, wherein the first indentation has a radius greater than that of the second indentation.

7. (canceled)

8. The atomization device according to claim 1, wherein the transmission pipe is perpendicular to the first chamber.

9. The atomization device according to claim 1, wherein the transmission pipe is slantwise configured relative to the first chamber.

10. The atomization device according to claim 2, wherein the encircling indentation has a depth twice as large as that of the central indentation.
